(19) United States
(12) Patent Application Publication
(10) Pub. No.: US 2022/0313532 A1
(43) Pub. Date: Oct. 6, 2022

(54) FOOT FLEXURE DEVICE

(71) Applicant: Waleed Al-Oboudi, San Diego, CA (US)

(72) Inventor: Waleed Al-Oboudi, San Diego, CA (US)

(21) Appl. No.: 17/657,860

(22) Filed: Apr. 4, 2022

Related U.S. Application Data
(60) Provisional application No. 63/170,867, filed on Apr. 5, 2021.

(51) Int. Cl. A61H 1/02

(52) U.S. Cl. CPC A61H 1/0266; A61H 2201/1642; A61H 2205/12; A61H 2201/165; A61H 2201/1676; A61H 2203/0431

(57) ABSTRACT

A foot flexure device is provided. The foot flexure device includes a foot plate configured to be positioned under a user's foot and a support element configured to be worn on a user's upper leg. A first adjustable strap is attached to a first lateral side of the foot plate and the support element, and a second adjustable strap is attached to a second lateral side of the foot plate and the support element. A first length of the first adjustable strap and a second length of the second adjustable strap can be adjustable to provide for dorsiflexion, eversion, and/or inversion of the user's foot.

### PRIORITY APPLICATION(S)

This application claims priority to U.S. Provisional Application No. 63/170,867, filed Apr. 5, 2021, which is incorporated herein by reference. Any and all applications for which a foreign or domestic priority claim is identified in the Application Data Sheet as filed with the present application are hereby incorporated by reference under 37 CFR 1.57.

### BACKGROUND

### Field

This application relates generally to orthotic, therapeutic, and stretching devices, and in particular, to a foot flexure device configured to help a user stretch his or her foot in dorsiflexion, eversion, and/or inversion.

### Description

Ankle and foot mobility is important for posture and movement. Restricted ankle or foot mobility can cause a host of problems that can affect the entire body. Modern living, which frequently involves sitting for long periods of times, can lead to tight calf muscles and/or other problems that limit ankle and foot mobility. Accordingly, there is a need for a device that can be used as a therapy aid to help users recover or improve ankle and foot mobility.

### SUMMARY

The foot flexure systems, methods and devices described herein have innovative aspects, no single one of which is indispensable or solely responsible for their desirable attributes. Without limiting the scope of the claims, some of the advantageous features will now be summarized.

A foot flexure device is configured to help a user stretch his or her foot or ankle in dorsiflexion, eversion, and/or inversion. The foot flexure device can be configured for use while sitting, allowing the user to advantageously improve foot and/or ankle mobility by using the device while seated.

In a first aspect, a foot flexure device includes a foot plate configured to be positioned under a user's foot, a support element configured to be worn on a user's upper leg, a first adjustable strap attached to a first lateral side of the foot plate and the support element, and a second adjustable strap attached to a second lateral side of the foot plate and the support element. A first length of the first adjustable strap and a second length of the second adjustable strap are adjustable to provide for dorsiflexion, eversion, and/or inversion of the user's foot.

In some embodiments, the device can provide for simultaneous dorsiflexion and eversion of the foot. In some embodiments, the device can provide for simultaneous dorsiflexion and inversion of the foot. In some embodiments, the support element comprises a wrap configured to be wrapped around the users' thigh.

In another aspect, a method includes positioning a foot plate under a user's foot, positioning a support element on a user's upper leg, adjusting a first length of a first adjustable strap attached to a first lateral side of the foot plate and the support element, and adjusting a second length of a second adjustable strap attached to a second lateral side of the foot plate and the support element, wherein adjusting the first length of the first adjustable strap and the second length of the second adjustable strap is configured to provide for dorsiflexion, eversion, and/or inversion of the user's foot.

In some embodiments, the method further comprises providing simultaneous dorsiflexion and eversion of the foot. In some embodiments, the method further comprises providing simultaneous dorsiflexion and inversion of the foot. In some embodiments, the support element comprises a wrap configured to be wrapped around the users' thigh.

### BRIEF DESCRIPTION OF THE DRAWINGS

The above-mentioned aspects of the foot flexure systems, methods, and devices described herein, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIGS. 1-3 illustrate various views of an embodiment of a foot flexure device. The illustrated embodiment includes a foot plate attached to a support element by adjustable straps. The support element may be configured as a wrap configured to be worn around a user's thigh.

FIG. 1 is a top view of the foot flexure device with the foot plate attached to the support element by two adjustable straps.

FIG. 2 is a side view the foot flexure device with the foot plate attached to the support element by two adjustable straps.

FIG. 3 illustrates the foot plate and adjustable straps detached from the support element.

FIGS. 4-6 illustrates additional views of the foot flexure device of FIGS. 1-3 during use. As shown, the support element is configured as wrap that is worn around the user's thigh. Two adjustable straps extend downwardly to the foot plate that is positioned below the user's foot.

FIG. 4 is a top, side view of the foot flexure device during use showing the support element, adjustable straps, and foot plate.

FIG. 5 is a top view of the foot flexure device showing the support element.

FIG. 6 is a front view of the foot flexure device showing the foot plate with adjustable straps attached thereto positioned below the user's foot.

### DETAILED DESCRIPTION

This application is directed to a foot flexure device. The foot flexure device is configured to help a user stretch his or her foot or ankle in dorsiflexion, eversion, and/or inversion. As the foot flexure device is configured to provide stretching in more than one direction (e.g., dorsiflexion and eversion or dorsiflexion and inversion), in some embodiments, the foot flexure device may be considered a multiangle foot flexure device. In other embodiments, the device may be configured to stretch the foot in a single direction (e.g., dorsiflexion, eversion, or inversion). Additionally, the foot flexure device can be configured for use while sitting, allowing the user to advantageously improve foot and/or ankle mobility by using the device while seated.

In the following detailed description, reference is made to the accompanying drawings, which form a part of the present disclosure. These illustrative embodiments are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and form part of this disclosure.

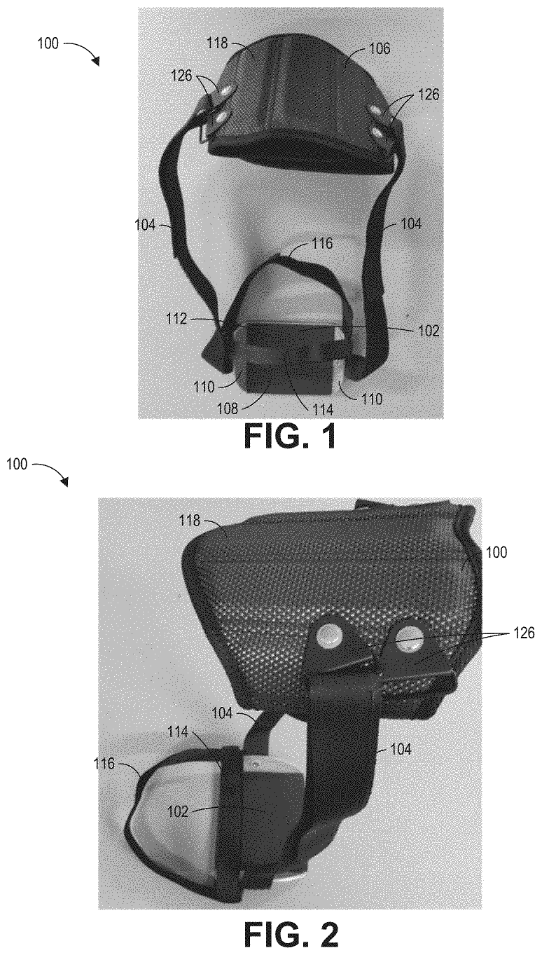

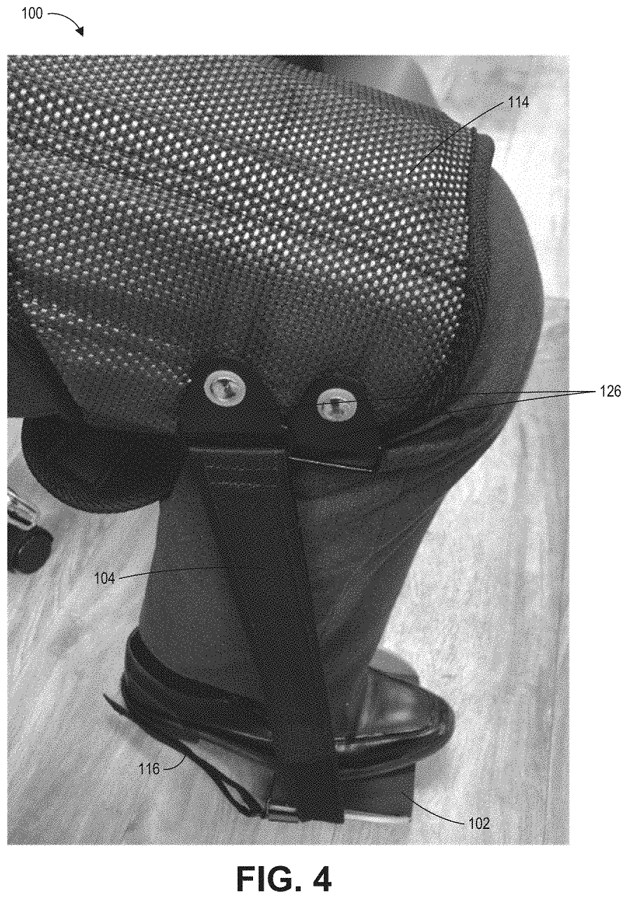

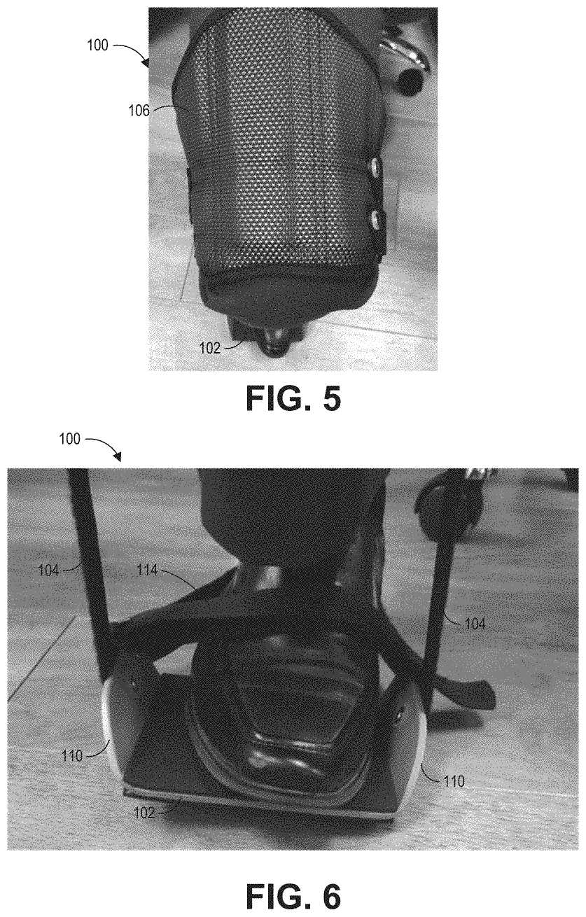

FIGS. 1-6 illustrate various views of an embodiment of a foot flexure device 100. FIGS. 1-3 illustrate the foot flexure device 100 alone, while FIGS. 4-6 illustrate the foot flexure device during use, for example, as worn by a user. With reference FIGS. 1-3, the components of the foot flexure device 100 will be first be described. Afterwards, example use of the foot flexure device 100 will be described with reference to FIGS. 4-6. As noted previously, the embodiment illustrated in FIGS. 1-6 is provided by way of example and illustration and is not intended to be limiting. Those of ordinary skill in the art will appreciate that, upon consideration of this disclosure, various modifications can be made.

As shown in FIGS. 1-3, the foot flexure device 100 comprises a foot plate 102, adjustable straps 104, and a support element 106. As best shown in FIGS. 1 and 2, the adjustable straps 104 extend between the foot plate 102 and the support element 106.

The foot plate 102 is configured to be positioned below the user's foot. In some embodiments, for example, as illustrated, the foot plate 102 is configured to extend under only a portion of the user's foot, such as under the user's forefoot (see, for example, FIGS. 4 and 6). In other embodiments, the foot plate 102 may be configured to extend under substantially all of the user's foot. The foot plate 102 may comprise a substantially flat plate 108. During use, the flat plate 108 is positioned below and supports the user's foot.

In some embodiments, wings 110 may be formed at the lateral edges of the flat plate 108. The wings 110 may provide attachments points for connecting the foot plate 102 to the adjustable straps 104. The wings 110 may be formed at angle with respect to the flat plate 108. For example, in some embodiments, the wings 110 are formed at an angle of about 30 degrees, about 45 degrees, about 60 degrees, about 75 degrees, or about 90 degrees relative to the flat plate 108. The angle of the wings 110 may help to transfer forces between the flat plate 108 of the foot plate 102 and the adjustable straps 104 and/or help to locate or center the user's foot on the foot plate 102. In some embodiments, the wings 110 may be omitted.

In the illustrated embodiment, the flat plate 108 and the wings are unitarily formed, although this need not be the case in all embodiments. The foot plate 102 (e.g., the flat plate 108 and the wings 110) can be made from a generally rigid material. In some embodiments, the foot plate 102 is formed from metal, such as aluminum, steel, or other metals and allows. As shown in FIGS. 1-3, in some embodiments, a cushion and/or traction material 112 can be applied to an upper surface of the foot plate 102 (e.g., to an upper surface of the flat plate 108). The cushion and/or traction material 112 can provide cushioning and/or traction below the user's foot which can increase comfort and useability of the foot flexure device 100.

As noted previously, the foot plate 102 is attached to the support element 106 by adjustable straps 104. As shown in the figures, the foot plate 102 may include or be attached to one or more additional straps. For example, in the illustrated embodiment, the foot plate 102 is attached to a foot strap 114 and a heel strap 116. One or more of the foot strap 114 and the heel strap 116 can be omitted in some embodiments. The foot strap and the heel strap 116 can be configured to secure the user's foot to the foot plate 102 during use, as shown, for example, in FIGS. 4 and 6, which are described in more detail below. In the illustrated embodiment, the foot strap 114 is configured to be secured over the top of the user's foot and to provide a downward force that holds the user's foot down onto the foot plate 102. The heel strap 116 is configured to be secured around the back of the user's heel or ankle and is configured to help to locate the user's foot on the foot plate 102. In the illustrated embodiment, the foot strap 114 and the heel strap 116 attach to the foot plate 102 at the wings 110. This need not be the case in all embodiments, and the foot strap 114 and/or the heel strap 116 can attach to the foot plate 102 at other locations.

In some embodiments, one or both of the foot strap 114 and/or the heel strap 116 are configured to be adjustable. This can facilitate fitting the foot flexure device to user's with a wide variety of foot sizes. In some embodiments, the foot strap 114 and/or the heel strap 116 comprise flexible straps with relatively minimal stretch. For example, in some embodiments, the foot strap 114 and/or the heel strap 116 can be made from nylon or other similar or suitable materials. The foot strap 114 and/or the heel strap 116 can include hook and loop fasteners that allow the straps to be attached over or around the user's foot at different positions so as to provide different length and tightness levels. In other embodiments, other fastening mechanisms can be used. In some embodiments, one or both of the foot strap 114 and/or the heel strap 116 can be replaced with laces, for example.

The foot plate 102 is also connected to the adjustable straps 104. As shown in the figures, the adjustable straps 104 are also connected to the support element 106. Before considering the adjustable straps 104 in detail, the support element 106 will first be described. In general, the support element 106 is configured to provide an anchor point for attaching the adjustable straps 104. In the illustrate embodiment, the support element 106 comprise a wrap 118 configured to be worn around the user's thigh. This, however, need not be the case in all embodiments. For example, the support element 106 need not extend entirely around the user's thigh. In some embodiments, the support element 106 extends only over the user's thigh, without extending around it, for example.

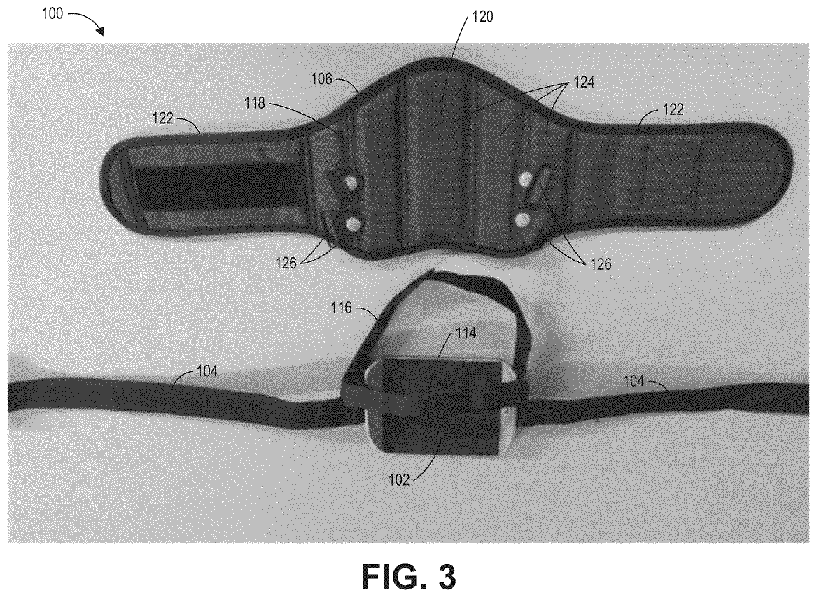

FIGS. 1 and 2 illustrate the wrap 118 in a closed configuration (e.g., representative of the configuration of the support element 106 during use, when worn around the user's thigh). FIG. 3 illustrates the wrap 118 in an open configuration with the wrap 118 laid out flat. As shown in FIG. 3, the wrap 118 can include a center section 120 and two lateral sections 122 extending outwardly from each lateral side of the center section 120. In use, the center section 120 can extend over the top or front of the user's thigh and the lateral sections 122 can wrap around the user's leg and attach to each other to secure the support element 106. Accordingly, the lateral sections 122 can include fastener mechanisms, such as hook and loop fasteners, that are configured to secure to each other. Other fastener mechanisms can also be used.

In some embodiments, the center section 120 can be wider than the lateral sections 122. Inclusion of a wide center section 120 can be advantageous as that it may increase the comfort of the foot flexure device 100 by distributing the weight and forces applied to the user's thigh over a generally large area.

In embodiments where the support element 106 is configured as a wrap 118 configured to be worn around the user's thigh, the wrap 118 can comprise a generally flexible material, such a fabric. In some embodiments, the wrap 118 comprises nylon or other similar or suitable materials. As shown, for example, in FIG. 3, the center section 120 may include one or more sections 124. The sections 124 may comprise padding material to further include the comfort of the device. Inclusions of the sections 124 may further help to allow the wrap to conform to the shape of the user's leg.

As shown in FIG. 3, attachment mechanisms 126 are provided on the support element 106. The attachment mechanisms 126 are configured to receive and attach to the adjustable straps 104. In the illustrated embodiment, the support element 106 includes four attachment mechanism 126. This would allow up to four adjustable straps 104 to be attached to the support element. Other numbers of attachment mechanisms 126 may also be used in other embodiments. For example, in some embodiments, two attachment mechanisms 126 may be used for connecting to two adjustable straps 104. In the illustrated embodiment, the attachment mechanisms are provided on the support element such that the adjustable straps can be connected or attached thereto generally on each side of the user's leg, as shown, for example, in FIGS. 1, 2, 4, 5, and 6. This configuration allows at least one adjustable strap 104 to extend down each side of the user's leg to connect to the foot plate 102.

With reference to at least FIGS. 1-3, the adjustable straps 104 will now be described. In the illustrated embodiment, the foot flexure device 100 includes two adjustable straps 104, with one provided on each lateral side of the foot flexure device 100. In other embodiments, other numbers of adjustable straps 104 may be provided, such as four straps, with two straps provided on each lateral side of the foot flexure device 100. In some embodiments, the adjustable straps 104 comprise flexible straps with relatively minimal stretch. For example, in some embodiments, the adjustable straps 104 can be made from nylon or other similar or suitable materials. As will be described in more detail below, the length of the adjustable straps 104 between the support element 106 and the foot plate 102 can be adjusted to both (1) allow the foot flexure device 100 to fit user's of wide variety of sizes, and (2) to impart forces on the foot plate 102 to provide for dorsiflexion, eversion, and/or inversion of the foot or ankle.

Various mechanisms for adjusting the length of the adjustable straps 104 can be provided. For example, in some embodiments, the point at which the adjustable straps 104 attach to the attachment mechanisms 126 of the support element 106 can be adjusted. The attachment mechanisms 126 can comprises eyes, rings, or loops through which the adjustable straps 104 are fed. More or less of the adjustable straps 104 can be moved through the attachment mechanisms 126 to adjust the lengths of the adjustable straps 104. In another embodiment, the adjustable straps 104 may be folded or doubled back on themselves and secured with a fastener, such as a hook and loop fastener. Attaching the fastener at different positions can be used to adjust the length of the adjustable straps 104. As described herein, the length of the adjustable straps 104 that can be adjusted can control the maximum distance between the foot plate 102 and the support element. By controlling or adjusting that distance, forces can be imparted on the foot plate 102 to provide for dorsiflexion, eversion, and/or inversion of the foot or ankle.

Example use of the foot flexure device 100 will now be described with reference to FIGS. 4-6. As shown in FIG. 4, the foot plate 102 is positioned below the user's foot and the support element 106 (configured in the figures as the wrap 118) is positioned on a user's thigh. The foot plate 102 is connected to the support element 106 by the adjustable straps 104. The length of the adjustable straps 104 can be adjusted to fit the user and flex the foot and angle. For example, as shown in FIG. 4, by shortening the adjustable straps 104, the user's foot may be brought into dorsiflexion, by pulling the front of the user's foot in an upward direction. FIG. 6 illustrates that the adjustable straps 104 may also be adjusted to provide for eversion or inversion of the foot. For example, by shortening the adjustable strap 104 that extends down the outside of the user's leg, the foot may be brought into eversion. Alternatively, by shortening the adjustable strap 104 that extends down the inside of the user's leg, the foot may be brought into inversion. In some embodiments, additional adjustable straps 104 may be used to increase the force applied to the foot plate 102. For example, two additional straps 104 can be connected to the additional attachment mechanisms 126 of the support element 106 to provide increased force.

Thus, by varying the length of the adjustable strap 104, the foot flexure device 100 may be configured to provide several types of stretching to the user's foot and/or ankle. For example, dorsiflexion, eversion, or inversion of the foot can be accomplished. Further, in some embodiments, more than one of these stretches can be provided simultaneously. For example, the foot flexure device 100 can be used to provide for simultaneous dorsiflexion and eversion of the foot or for simultaneous dorsiflexion and inversion of the foot.

As best shown in FIG. 4, the foot flexure device 100 can be configured for use in a seated position. In this way, the user's upper leg (e.g., thigh and/or knee) provides an anchor point for the foot plate 102. Use of the device 100 can also be advantageous as it provides for simple and easy stretching while seated. The user may adjust the straps 104 as desired and then stretch with the aid of the device 100.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate that direction terms, such as “upper” and “lower,” are sometimes used for ease of describing the figures, and indicate relative positions corresponding to the orientation of the figure on a properly oriented page, and may not reflect the proper orientation of the device as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

In describing the present technology, the following terminology may have been used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

Elements that are described as “connected,” “engaged,” “attached,” or similarly described, shall include being directly and/or indirectly connected, engaged, attached, etc.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Conjunctions, such as “and,” “or” are used interchangeably and are intended to encompass any one element, combination, or entirety of elements to which the conjunction refers.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims that follow.

What is claimed is:

1. A foot flexure device comprising:
a foot plate configured to be positioned under a user's foot;
a support element configured to be worn on a user's upper leg; and
a first adjustable strap attached to a first lateral side of the foot plate and the support element;
a second adjustable strap attached to a second lateral side of the foot plate and the support element;
wherein a first length of the first adjustable strap and a second length of the second adjustable strap are adjustable to provide for dorsiflexion, eversion, and/or inversion of the user's foot.

2. The device of claim 1, wherein the device can provide for simultaneous dorsiflexion and eversion of the foot.

3. The device of claim 1, wherein the device can provide for simultaneous dorsiflexion and inversion of the foot.

4. The device of claim 1, wherein the support element comprises a wrap configured to be wrapped around the users' thigh.

5. A method comprising:
positioning a foot plate under a user's foot;
positioning a support element on a user's upper leg; and
adjusting a first length of a first adjustable strap attached to a first lateral side of the foot plate and the support element; and
adjusting a second length of a second adjustable strap attached to a second lateral side of the foot plate and the support element;
wherein adjusting the first length of the first adjustable strap and the second length of the second adjustable strap is configured to provide for dorsiflexion, eversion, and/or inversion of the user's foot.

6. The method of claim 5, further comprising providing simultaneous dorsiflexion and eversion of the foot.

7. The method of claim 5, further comprising providing simultaneous dorsiflexion and inversion of the foot.

8. The method of claim 5, wherein the support element comprises a wrap configured to be wrapped around the users' thigh.
